(19) United States
(12) Patent Application Publication
(10) Pub. No.: US 2023/0196845 A1
(43) Pub. Date: Jun. 22, 2023

(54) METHOD, CONTROL APPARATUS AND SYSTEM FOR OPERATING A MOTOR VEHICLE, AND MOTOR VEHICLE

(71) Applicant: AUDI AG, Ingolstadt (DE)

(72) Inventor: Ingo TOTZKE, Ingolstadt (DE)

(73) Assignee: AUDI AG, Ingolstadt (DE)

(21) Appl. No.: 17/996,314

(22) PCT Filed: Mar. 10, 2021
(86) PCT No.: PCT/EP2021/055985

§ 371 Date: Oct. 14, 2022

(30) Foreign Application Priority Data
Apr. 15, 2020 (DE) 10 2020 110 234.8

(51) Int. Cl. G07B 15/02

(52) U.S. Cl. CPC G07B 15/02

(57) ABSTRACT

The present disclosure relates to a method for operating a motor vehicle, wherein current position data of the motor vehicle is detected by at least one sensor device inside the motor vehicle, and a current position of the motor vehicle is determined based on the position data. A check is made as to whether a current occupancy condition exists for the current position, and, if so, an authorization data record is generated depending on the current occupancy condition. The authorization data record is transmitted by a communication link from a transceiver of the motor vehicle to a server device external to the motor vehicle, where a check is made as to whether an occupancy authorization certificate for the motor vehicle can be generated based on the authorization data record. If so, the occupancy authorization certificate is ultimately generated based on the authorization data record.

### TECHNICAL FIELD

The present disclosure relates to a method for operating a motor vehicle, a control device which is designed and configured to perform the method, a motor vehicle having such a control device and a system for operating a motor vehicle.

### BACKGROUND

Motor vehicles are increasingly moving independently or autonomously on the road. The movement of a motor vehicle also includes parking it in a designated parking area. A parking area may be, for example, a parking area or a parking lot or a multi-story parking garage or a private parking space. As is known, parking or occupancy conditions are generally applicable for known parking areas. Such a condition may be, for example, a payment condition and/or a time limit for the occupancy. Alternatively or additionally, the occupancy condition may include that only motor vehicles which are not smaller or larger than predetermined dimensions may be parked in a parking area to which the occupancy condition applies. It is also conceivable that specific parking spaces are reserved for specific users or their motor vehicles or that the use thereof is reserved for them.

In order to meet a parking condition, it is normally necessary for a user of the motor vehicle to communicate or interact with an infrastructure, for example a parking ticket machine. In the simplest case, this communication consists of the user of the motor vehicle purchasing a parking ticket at the parking ticket machine. In addition, the use of special payment apps or payment programs (e.g., so-called “mobile phone parking”) which may be installed on a mobile device, e.g., a smartphone, of a user is known. Especially when parking in designated parking areas, for example in multi-story parking garages or underground parking garages (so-called off-street parking), there is also the option of using the user's credit card to pay for a parking ticket when entering and exiting a gate.

DE 20 2014 006 028 U1 describes a further possibility of a parking ticket purchase activated by the user. Here, a user of a motor vehicle may activate a payment process for paying for a parking ticket by pressing a corresponding button in the motor vehicle. This results in the disadvantage that the user often cannot be aware that his vehicle is in a chargeable area or that he simply forgets to initiate the payment process.

A parking condition may also be met automatically. In the case of automated satisfaction of a condition, an action by a user of the motor vehicle is not absolutely necessary. In other words, the automated satisfaction of a condition may be accomplished via an interaction between the motor vehicle (in the case of a fully autonomous motor vehicle) and a particular infrastructure component. For example, so-called tags or markings on a vehicle window or a vehicle license plate may be automatically detected by appropriately designed sensors of a parking infrastructure, and a parking ticket may be issued based on the detection.

In this context, US 2017/0116790 A1 describes a system and a method for automatic parking, for example in a parking garage. The parking garage has monitored parking spaces, wherein a parking space is equipped with sensors which register whether a parking space is free or occupied.

A system described by WO 2018/088704 A1, which detects the entry and exit of a vehicle in relation to a chargeable parking lot, works in a similar way.

The methods described for purely infrastructure-based detection of a motor vehicle have the disadvantage that, in order to ensure reliable operation of the systems described, an unmanageable number of sensors must be installed within the parking infrastructure. In particular for sensors that are installed within a roadway surface, there is a particularly high susceptibility to wear and thus such a system is highly cost-intensive. In addition, it cannot be reliably ensured that a particular vehicle is also correctly identified.

### BRIEF DESCRIPTION OF DRAWINGS/FIGURES

FIG. 1 illustrates a schematic representation of a system for operating a motor vehicle.

FIG. 2 illustrates a schematic representation of a method for operating a motor vehicle.

### DETAILED DESCRIPTION

The object of the present disclosure is to provide a simplified method for authorizing a motor vehicle at a current position, for example within a parking area.

The problem is solved by the subject matter of the independent claims. Advantageous developments of the present disclosure are described by the dependent claims, the subsequent description, and the drawings.

The present disclosure provides a method for operating a motor vehicle. The method relates in particular to a situation in which the motor vehicle is parked and/or is to be parked in a parking area provided for this purpose. Irrespective of this, the method may generally relate to situations in which an authorization certificate or an occupancy authorization certificate is to be generated for the motor vehicle, which certificate entitles or authorizes the motor vehicle to occupy a predetermined location.

In the course of the method, current position data of the motor vehicle are recorded at least by means of a sensor device inside the motor vehicle. In other words, the current position is determined at least partially by the motor vehicle itself. The sensor device inside the vehicle may comprise one or more sensors. For example, a camera and/or a motion sensor and/or a sensor for detecting a currently set steering angle and/or a sensor for determining a global position (GNSS or GPS sensor) may be considered as a sensor. Furthermore, it is conceivable that the sensor device communicates with one or more driver assistance systems present in the motor vehicle in order to integrate their data for position determination. A driver assistance system may be a lane departure warning system or a distance control assistant, for example. In other words, various sensor data are preferably consolidated inside the motor vehicle in order to determine the current position of the motor vehicle.

The method also provides for checking whether a current occupancy condition exists for the current position of the motor vehicle. This may be accomplished, for example, by means of a database comparison, which may be performed between the determined current position and map data available for the motor vehicle or meta information data in general. For example, it is conceivable for map data to be made available for the motor vehicle, wherein the map data comprise metadata, which include information about current occupancy conditions at different positions or locations that are covered by a particular map. These map data may be provided for the motor vehicle, for example, via a wireless connection, for example a Car-to-X connection. They may be stored on a backend server and/or placed in a local database of the motor vehicle.

If the check is affirmative, i.e., if a current occupancy condition exists for the current position of the motor vehicle, in a next step an authorization data record is generated depending on the current occupancy condition. For the exemplary case of a parking ticket purchase, an affirmation of the check may mean that it has been determined that the motor vehicle is currently in a paid parking area. The occupancy condition is that a certain amount of money has to be paid. A corresponding authorization data record could therefore contain corresponding payment information, for example.

The method also provides for establishing a communication link between a transceiver of the motor vehicle and a server device external to the motor vehicle. The communication link may be, for example, a radio connection or an Internet connection or a. The motor vehicle's transceiver provided for communication may be, for example, an antenna unit designed and configured for this purpose having a corresponding communication module. In connection with the transceiver, a person skilled in the art will rely on devices of this type that are known to him. The server device external to the motor vehicle may be a backend server or a cloud server. It is quite conceivable that third parties, for example official parking violation inspectors, may also be granted access to the server device external to the motor vehicle.

The previously generated authorization data record is transmitted from the motor vehicle to the server device by means of the described communication link.

In a next step, a check is first made as to whether an occupancy authorization certificate may be generated for the motor vehicle based on the authorization data record. Finally, it may also be the case that the authorization data record contains incorrect or insufficient information, so that no occupancy authorization certificate for the motor vehicle may be generated based on the authorization data record. In the exemplary case of purchasing a parking ticket, this may be the case, for example, if not enough has been paid for and/or the desired parking space is reserved for another motor vehicle or another user. The information about how much has to be paid for the parking space or whether the parking space is reserved may be present in the server device as a database entry in a parking space database. In other words, the check as to whether an occupancy authorization certificate may be generated for the motor vehicle based on the authorization data record may be carried out in the server device. The server device may have a corresponding software program for this. The software program may have a comparison algorithm, for example, which can perform the database comparison to the parking space database.

If the check can be answered in the affirmative, i.e., if an occupancy authorization certificate can be generated based on the authorization data record for the motor vehicle, which entitles the motor vehicle to occupy the current position, then it is generated. For the exemplary case mentioned above, in which the motor vehicle is in a chargeable parking area, the occupancy authorization certificate may be generated in the form of an electronic parking ticket. There are various possible ways in which such an occupancy authorization certificate may be displayed. These options are described in more detail below.

However, if it is determined that based on the authorization data record no occupancy authorization certificate can be created for the motor vehicle, a warning may be issued to a motor vehicle user, for example, who then knows that he must exit the current position with the motor vehicle. An autonomously controlled motor vehicle may receive a corresponding warning signal and may exit its current position depending on the warning signal.

The method according to the present disclosure makes it possible to determine in a particularly simple and reliable manner whether a motor vehicle's occupation of a specific position can be authorized at all. If this is the case, the method according to some embodiments may be used to generate a corresponding authorization certificate in a particularly reliable and convenient manner. An inadvertent missing of an occupancy condition, for example by a user of the motor vehicle, is thus advantageously ruled out. The fact that it is possible to determine inside the vehicle whether a particular occupancy condition must be met means that complex sensor arrangements, for example on the part of the parking infrastructure, may advantageously be dispensed with. The method according to the present disclosure is to be regarded as particularly advantageous in connection with autonomous or fully autonomous motor vehicles.

An aspect of the invention also includes further embodiments, which offer additional advantages.

One embodiment provides that a driving maneuver monitoring routine is also carried out, wherein it is observed as part of the driving maneuver monitoring routine whether, for example, a specific gear is engaged in the motor vehicle and/or a predetermined steering angle is set and/or a drop in the on-board voltage (terminal 12) is observed and/or whether a drive engine of the motor vehicle is switched on or off. If at least one operating parameter characteristic of a behavior of the motor vehicle at the current position is detected during the course of the driving maneuver monitoring routine, the communication link is established and the authorization data record is generated and transmitted to the server device. In other words, the communication between the motor vehicle and the server device external to the motor vehicle only takes place if it is detected as necessary due to the presence of the at least one characteristic operating parameter. For the exemplary case described above that the motor vehicle is to be parked in a chargeable parking area, this may mean, for example, that the payment information is only generated and transmitted to the server device if it is also determined that an action typical of a parking maneuver is being carried out. This typical action can cause the described characteristic operating parameter. A typical action for a parking maneuver would be, for example, engaging gear P in an automatic transmission. This results in the advantage that the authorization data record is not generated and transmitted prematurely or unnecessarily.

A further embodiment provides that the occupancy authorization certificate for the motor vehicle is displayed by means of at least one display device configured for this purpose. Such a display device may be located, for example, on or in the motor vehicle and is preferably visible from the outside. However, a mobile terminal, for example a smartphone, may also be used as such a display device. In other words, a smartphone or another mobile terminal, which preferably has wireless technology, may be integrated into the communication link. Corresponding software or a corresponding computer program may advantageously be stored and run on the smartphone for this purpose. A device trained and configured for this purpose by an official parking violation inspector may also be used as a display device. For example, a message generated by the server device, according to which a corresponding payment information data record has been received, for example, may be retrieved directly on such a device.

An authorization query may preferably take place before the authorization data record is transmitted. This results in the advantage that a user retains the authority to decide whether the authorization data record should actually be transmitted.

It may happen that a current occupancy condition changes over time. For example, in the case of many parking areas, payment is only required at a predetermined time or within a predetermined period of time. According to one advantageous embodiment, it is therefore provided that if there is a change in the current occupancy condition and/or depending on the particular current position of the motor vehicle and/or, if there is at least one operating parameter of the motor vehicle that is characteristic of a change of the current position of the motor vehicle that has taken place or is imminent, a change data record is generated and transmitted to the server device external to the motor vehicle. The change data record is preferably transmitted automatically. This advantageously prevents an outdated and no longer valid occupancy condition from being incorrectly met. For the exemplary case of purchasing a parking ticket, this may mean that the change data record is generated and transmitted as soon as the motor vehicle leaves its parking position. This may be recognized, for example, by the fact that an engine of the motor vehicle is started and/or that it drives off. A change in a GPS position of the motor vehicle or a change in characteristic values of the driving dynamics, for example, may be used for this purpose. Data from a driver monitoring camera or data from seat occupancy sensors in the motor vehicle may also be used for this purpose.

A check is preferably made at predetermined time intervals as to whether a particular occupancy condition is still currently valid. Such a plausibility check may also be used to prevent an occupancy condition that is no longer valid from incorrectly being met.

According to an advantageous development, the change data record is not automatically transmitted to the server device, but is initiated by a user of the motor vehicle.

A further embodiment provides that user profile data is also transmitted to the server device by means of the communication link, and the authorization data record is generated or expanded depending on the user profile data. User profile data may include, for example, a preferred payment method and/or participation in bonus or fleet or subscription programs. User profile data may also include data from stored users of car-sharing offers. In this case, any parking fees incurred may preferably be added directly to the user booking the parking.

Some embodiments also relate to a control device for operating a motor vehicle, wherein the control device is designed and configured to receive current position data of the motor vehicle from at least one sensor device inside the motor vehicle and to determine a particular current position of the motor vehicle based on the position data. The control device is also designed and configured to check whether a current occupancy condition exists for the current position of the motor vehicle and, if so, to generate an authorization data record depending on the particular current occupancy condition. The control device is also designed and configured to establish a communication link between a transceiver of the motor vehicle and a server device external to the motor vehicle, to transmit the authorization data record by means of the communication link from the motor vehicle to the server device, and to receive an occupancy authorization certificate for the motor vehicle that is generated based on the authorization data record from the server device.

The control device has a processor device which is configured to implement an embodiment of the method according to an aspect of the invention. For this purpose, the processor unit may have at least one microprocessor and/or at least one microcontroller and/or at least one FPGA (field programmable gate array) and/or at least one DSP (digital signal processor). Furthermore, the processor device may have a program code which is configured to implement the embodiment of the method according to an aspect of the invention when executed by the processor device. The program code may be stored in a data memory of the processor means.

A motor vehicle having such a control device is also a part of the present disclosure. The motor vehicle according to the present disclosure is preferably designed as a car, in particular as a passenger car or truck or as a passenger bus or motorcycle.

Finally, the present disclosure also relates to a system for operating a motor vehicle, comprising a control device of the motor vehicle, which is designed to perform the method according to the present disclosure, and a server device external to the motor vehicle. The server device is designed and configured to perform the relevant steps of the method according to the present disclosure.

An aspect of the invention also includes developments of the control device according to the present disclosure, of the motor vehicle according to the present disclosure, and of the system according to the present disclosure which have features as were previously described in conjunction with the developments of the method according to the present disclosure. For this reason, the corresponding developments of the control device according to the present disclosure, the motor vehicle according to the present disclosure and the system according to the present disclosure are not described again here.

An aspect of the invention also comprises the combinations of the features of the described embodiments.

The embodiments described below are preferred embodiments of the present disclosure. In the embodiments, the described components of the embodiments each represent individual features of the present disclosure, which should be considered in isolation and which each develop the present disclosure independently of one another. The disclosure is therefore also intended to comprise combinations of the features of the embodiments other than those presented. Furthermore, the described embodiments may also be supplemented by further, previously described features of the present disclosure.

In the figures, the same reference signs denote functionally identical elements.

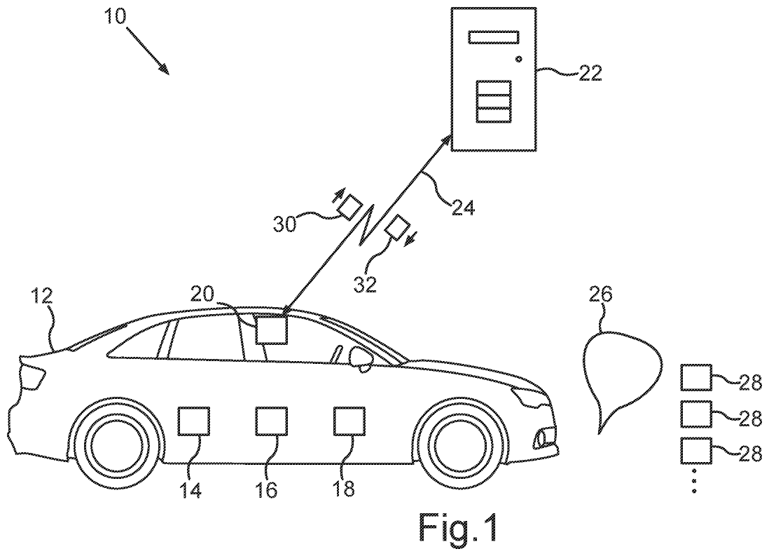

FIG. 1 illustrates a schematic representation of a system 10 for operating a motor vehicle 12. The motor vehicle 12 may have a sensor device 14, a control device 16 and a display device 18. In addition, the motor vehicle 12 may have a transceiver unit 20. The system 10 also comprises a server device external to the motor vehicle 22 which may be connected to the transceiver unit 20 of the motor vehicle 12 by means of a communication link 24.

In an exemplary situation, the motor vehicle 12 may move autonomously or at least partially autonomously between different positions. The motor vehicle 12 or the control device 16 of the motor vehicle 12 may use the sensor device 14 inside the motor vehicle to record current position data of the motor vehicle 12 and use the position data to determine a particular current position 26 of the motor vehicle 12. The control device 16 may additionally check whether a current occupancy condition 28 for the current position 26 of the motor vehicle 12 exists. For example, the current position 26 may be a position within a chargeable parking lot. The control device 16 is able to determine that the current position 26 is a chargeable parking space, for example, based on a comparison to a highly accurate map that is available to it, wherein parking spaces may be entered in the map. Provision may be made for the control device 16 to additionally perform a driving maneuver monitoring routine in order to also determine whether the motor vehicle 12 is also actually parked in the current position 26. The question as to whether the motor vehicle 12 is to be parked may be answered in the affirmative if an operating parameter that is characteristic of a parking process is detected. Such an operating parameter may be, for example, engaging a reverse gear and/or setting a predetermined steering angle.

As a result, the control device 16 is able to generate an authorization data record 30 depending on the particular current occupancy condition 28. If a parking ticket is purchased, the authorization data record 30 may contain, for example, the corresponding payment information. The authorization data record 30 may now be transmitted via the communication link 24 from the transceiver 20 of the motor vehicle 12 to the server device external to the motor vehicle 22. The authorization data record 30 may be processed in the server device 22, and a check may be made as to whether an occupancy authorization certificate 32 for the motor vehicle 12 can be generated based on the authorization data record 30. If this is the case, a corresponding certificate 32 may be generated in the server device 22.

The occupancy authorization certificate 32 may be displayed in the motor vehicle 12 by means of the display device 18, for example.

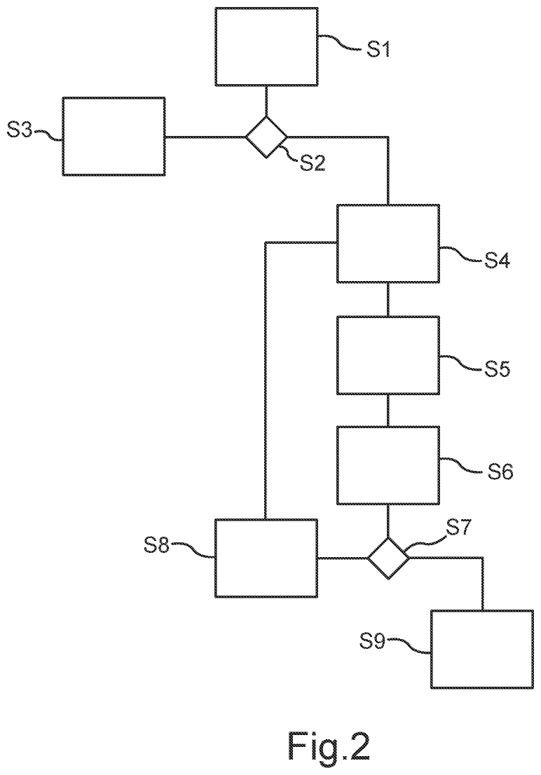

With reference to the components labeled and described in connection with FIG. 1, FIG. 2 illustrates a schematic representation of a method for operating a motor vehicle 12. In a method step S1, current position data of the motor vehicle 12 are recorded at least by means of a sensor device 14 inside the vehicle and a current position 26 of the motor vehicle 12 is determined based on the position data. In a method step S2, a check is made as to whether at least one current occupancy condition 28 exists for the determined and current position 26 of the motor vehicle 12. If the answer to this check is negative, a corresponding warning may be output to a user of the motor vehicle 12 in step S3, for example, and the method may be aborted. However, if the answer to this check is yes, the method is preferably continued as follows.

In a method step S4, an authorization data record 30 may be generated depending on the current occupancy condition 28 in each case. In a method step S5, a communication link 24 is established between a transceiver device 20 of the motor vehicle 12 and a server device 22 external to the motor vehicle. In a method step S6, the authorization data record 30 is transmitted from the motor vehicle 12 to the server device 22 external to the motor vehicle by means of the communication link 24. The server device 22 then checks (step S7) whether an occupancy authorization certificate 32 can be generated for the motor vehicle 12 based on the authorization data record 30. If the answer to this check is negative, in a step S8, for example, a request may be sent to the motor vehicle 12 to generate the authorization data record 30 again and, if necessary, to transmit it. In other words, the method described would jump back to step S4. Alternatively, (and not shown here) the method could also be aborted after step S7 if the answer is negative. However, if the check in step S7 can be answered in the affirmative, an occupancy authorization certificate 32 for the motor vehicle 12 based on the authorization data record 30 is finally generated in a subsequent method step S9.

Known methods provide that as soon as a vehicle is parked in a chargeable area (e.g., at the side of the road, in designated parking areas or in multi-story or underground parking garages), the driver must purchase a ticket. This is e.g., possible by buying a parking ticket at the parking machine or by using a payment app when parking on the side of the road (so-called on-street parking). Especially when parking in designated parking areas, in multi-story parking garages or underground parking garages (so-called off-street parking), there is also the known possibility of using a credit card when driving in and out at the gate or using automatically detectable tags on the vehicle window or the detection of a license plate of the vehicle to pay for a parking ticket.

A disadvantage of the known methods is that, particularly in the case of on-street parking, the driver always has to perform at least one action in order to purchase a parking ticket (e.g., looking for and going to the ticket machine, looking for change or something that can be used for payment, calling up a smartphone app including storage of profile data for the vehicle including credit card information or similar).

To avoid these disadvantages, some embodiments propose, among other things, a system for automatic payment for parking tickets. This system is preferably based on information on available parking areas (e.g., at the side of the road, on parking areas, in multi-story parking garages/underground garages; e.g., via corresponding map information, camera data).

If the vehicle recognizes that a parking maneuver has been completed in an available parking area and the vehicle is parked (e.g., via aisle P or aisle R next to or in parking bays, possibly in combination with a calculation of the steering angle, terminal 12/engine off), this system becomes active and a parking ticket is automatically purchased. For this purpose, relevant information (e.g., vehicle license plate, payment method, participation in bonus, fleet or subscription programs) is preferably transferred to a server and preferably also made available to third parties (e.g., official parking violation inspectors). The driver does not have to purchase an additional ticket (e.g., at a ticket machine or via a payment app).

As soon as the driver finally completes the parking maneuver (e.g., detectable by the engine being on) and drives off (e.g., detectable by a change in the GPS position of the vehicle or characteristic values of the driving dynamics), relevant information is preferably transferred to the server again and the payment process is concluded.

Furthermore, the system may check at any time whether it is necessary to buy a parking ticket at the given time or whether the vehicle is, e.g., also parked at a free time (e.g., between 8 p.m. and 7 a.m. many parking spaces are free of charge). In this case, the purchase of the parking ticket is preferably stopped or started at the right time.

The driver also preferably has the option of calling up information about the booked parking ticket during the entire parking process (e.g., in the vehicle or via a corresponding app). If the maximum permitted parking time is reached, the driver should preferably be informed of this.

Alternatively, it is conceivable that the booking or completion of a parking ticket purchase does not take place automatically, but only after confirmation by the driver. In this case it would, for example, be possible for corresponding text information to be offered on a display in the vehicle interior (e.g., after parking the vehicle: “Would you like to purchase a parking ticket?” or when getting back into the vehicle: “Do you want to conclude the parking cycle?”).

This system is conceivable for vehicles parked manually, as well as for vehicles with assisted or automated parking.

With the proposed system for automatically paying for parking tickets, parking tickets may be conveniently purchased without having to go to the ticket machine, search for change or credit cards, etc.

This system is of particular interest for automatically parked vehicles in which there may not be a driver in the vehicle. There are also advantages for car-sharing offers, as the parking fees incurred (including potential reminder fees) may be charged directly to the person making the booking.

The present disclosure preferably provides for available parking areas to be determined (e.g., via a highly accurate map, which may be provided via a wireless connection, such as Car-to-X, via a backend server, a local database and/or camera data). A lane-precise determination of the position of the ego motor vehicle is preferably additionally provided. In addition, there is preferably the determination of a driving maneuver (e.g., via gear P/gear R in combination with the steering angle, terminal 12/engine off at the start of the parking maneuver or via gear D in combination with the steering angle and engine on at the end of the parking maneuver). A central server for ticket purchase and/or access by supervisory personnel is preferably present and integrated into the system. Vehicle data is preferably also transmitted to the central server (GPS position, start of parking, end of parking, payment method, etc.). A database with parking-relevant information (e.g., parking fees depending on the current time of day, maximum permitted parking time) is preferably available. There may be a connection to a smartphone app that a driver can use to call up information about the parking ticket at any time.

Overall, the examples show how a system for automatically paying for parking tickets may be provided.

1.-10. (canceled)

11. A method for operating a motor vehicle, the method comprising:
recording a current position data of the motor vehicle by at least one sensor device inside the motor vehicle;
determining a current position of the motor vehicle based on the current position data;
checking whether a current occupancy condition exists for the current position;
based on determining that a current occupancy condition exists, generating an authorization data record based on the current occupancy condition;
establishing a communication link between a transceiver of the motor vehicle and a server device external to the motor vehicle;
transmitting the authorization data record by the communication link from the motor vehicle to the server device;
checking, by the server device, whether an occupancy authorization certificate can be generated for the motor vehicle based on the authorization data record;
generating the occupancy authorization certificate for the motor vehicle, wherein the motor vehicle is parked or is to be parked on a parking area provided for this purpose;
checking, at a predetermined time interval, whether the current occupancy condition for the current position is valid;
based on determining that the current occupancy condition is invalid, generating a change data record; and
automatically transmitting the change data record to the server device.

12. The method according to claim 11, further comprises
detecting, by performing a driving maneuver observation routine, any operating parameter that is characteristic for a behavior of the motor vehicle at the current position,
wherein establishing the communication link between the transceiver and the server device is performed based on detecting at least one operating parameter that is characteristic for a behavior of the motor vehicle at the current position.

13. The method according to claim 11, wherein the occupancy authorization certificate for the motor vehicle is displayed by at least one display device configured for this purpose.

14. The method according to claim 11, further comprising:
querying an authorization for the transmission of the authorization data record.

15. The method according to claim 11, wherein generating the change data record and transmitting the change data record to the server device external to the vehicle are further based on the current position of the motor vehicle, or if there is at least one operating parameter of the motor vehicle that is characteristic for a change of the current position of the motor vehicle that has taken place or is imminent.

16. The method according to claim 11, wherein transmitting the change data record to the server device is initiated by a user of the motor vehicle.

17. The method according to claim 11,
wherein the authorization data record is adapted depending on a user profile data, and
wherein the user profile data is transmitted to the server device external to the vehicle by the communication link.

18. A control device for operating a motor vehicle, the control device being configured to:
receive current position data of the motor vehicle at least from a sensor device inside the motor vehicle;
determine a current position of the motor vehicle based on the current position data;
check whether a current occupancy condition exists for the current position;
based on determining that the current occupancy condition exists, generate an authorization data record depending on the current occupancy condition;
establish a communication link between a transceiver of the motor vehicle and a server device external to the motor vehicle;
transmit the authorization data record from the motor vehicle to the server device by the communication link;
receive, from the server device, an occupancy authorization certificate for the motor vehicle that is generated based on the authorization data record, wherein the motor vehicle is parked or is to be parked in a parking area provided for this purpose;
check, at predetermined time intervals, whether the current occupancy condition for the current position is valid;
based on determining that the current occupancy condition is invalid, generate a change data record; and
automatically transmit the change data record to the server device.

19. A motor vehicle comprising a control device, the control device being configured to:
receive current position data of the motor vehicle at least from a sensor device inside the motor vehicle;
determine a current position of the motor vehicle based on the current position data;
check whether a current occupancy condition exists for the current position;
based on determining that the current occupancy condition exists, generate an authorization data record depending on the current occupancy condition;
establish a communication link between a transceiver of the motor vehicle and a server device external to the motor vehicle;
transmit the authorization data record from the motor vehicle to the server device by the communication link;
receive, from the server device, an occupancy authorization certificate for the motor vehicle that is generated based on the authorization data record, wherein the motor vehicle is parked or is to be parked in a parking area provided for this purpose;
check, at predetermined time intervals, whether the current occupancy condition for the current position is valid;
based on determining that the current occupancy condition is invalid, generate a change data record; and
automatically transmit the change data record to the server device.

20. A system for operating a motor vehicle, the system comprising:
a server device external to the motor vehicle; and
a control device of the motor vehicle, wherein the control device is configured to perform a method comprising:
recording a current position data of the motor vehicle by at least one sensor device inside the motor vehicle;
determining a current position of the motor vehicle based on the current position data;
checking whether a current occupancy condition exists for the current position;
based on determining that a current occupancy condition exists, generating an authorization data record based on the current occupancy condition;
establishing a communication link between a transceiver of the motor vehicle and a server device external to the motor vehicle;
transmitting the authorization data record by the communication link from the motor vehicle to the server device;
checking, by the server device, whether an occupancy authorization certificate can be generated for the motor vehicle based on the authorization data record;
generating the occupancy authorization certificate for the motor vehicle, wherein the motor vehicle is parked or is to be parked on a parking area provided for this purpose;
checking, at a predetermined time interval, whether the current occupancy condition for the current position is valid;
based on determining that the current occupancy condition is invalid, generating a change data record; and
automatically transmitting the change data record to the server device.
